(19) United States
(12) Patent Application Publication
(10) Pub. No.: US 2007/0195544 A1
(43) Pub. Date: Aug. 23, 2007

(54) Remote controlled LED light bulb

(76) Inventor: Chester Graves JR., Westbury, NY (US)

Correspondence Address: MORGAN LEWIS & BOCKIUS LLP, 1111 PENNSYLVANIA AVENUE NW, WASHINGTON, DC, 20004, US

(21) Appl. No.: 11/698,809

(22) Filed: Jan. 25, 2007

Related U.S. Application Data
(60) Provisional application No. 60/762,571, filed on Jan. 26, 2006.

(51) Int. Cl. F21V 11/00

(52) U.S. Cl. 362/510

(57) ABSTRACT

The present invention relates to a remote controlled light bulb using a light emitting diode (LED). Advantageously, the light bulb includes a conventional mounting that allows it to be mounted in a conventional socket. The light emitting diode emits radiation at a first wavelength and advantageously includes known technology for converting some of the radiation to at least one other wavelength so as to provide an approximation to white light.

### CROSS REFERENCE TO RELATED APPLICATION

This application claims priority to provisional application No. 60/762,571, filed Jan. 26, 2006, which is incorporated herein by reference.

### SUMMARY OF THE INVENTION

The present invention relates to a remote controlled light bulb using a light emitting diode (LED). Advantageously, the light bulb includes a conventional mounting that allows it to be mounted in a conventional socket.

The light emitting diode emits radiation at a first wavelength and advantageously includes known technology for converting some of the radiation to at least one other wavelength so as to provide an approximation to white light.

### BRIEF DESCRIPTION OF THE DRAWINGS

These and other objects, features and advantages of the present invention will be more readily apparent from the following Detailed Description in which:

FIG. 1A is a schematic illustration of the remote controlled LED light bulb of the present invention;

FIG. 1B is a block diagram of a first embodiment of the remote controlled LED light bulb of the present invention;

FIG. 1C is a block diagram of a second embodiment of the remote controlled LED light bulb of the present invention;

FIG. 1D is a block diagram of a third embodiment of the remote controlled LED light bulb of the present invention; and

FIG. 2 is a detailed view of an illustrative embodiment of the remote controlled LED light bulb of the present invention.

### DETAILED DESCRIPTION

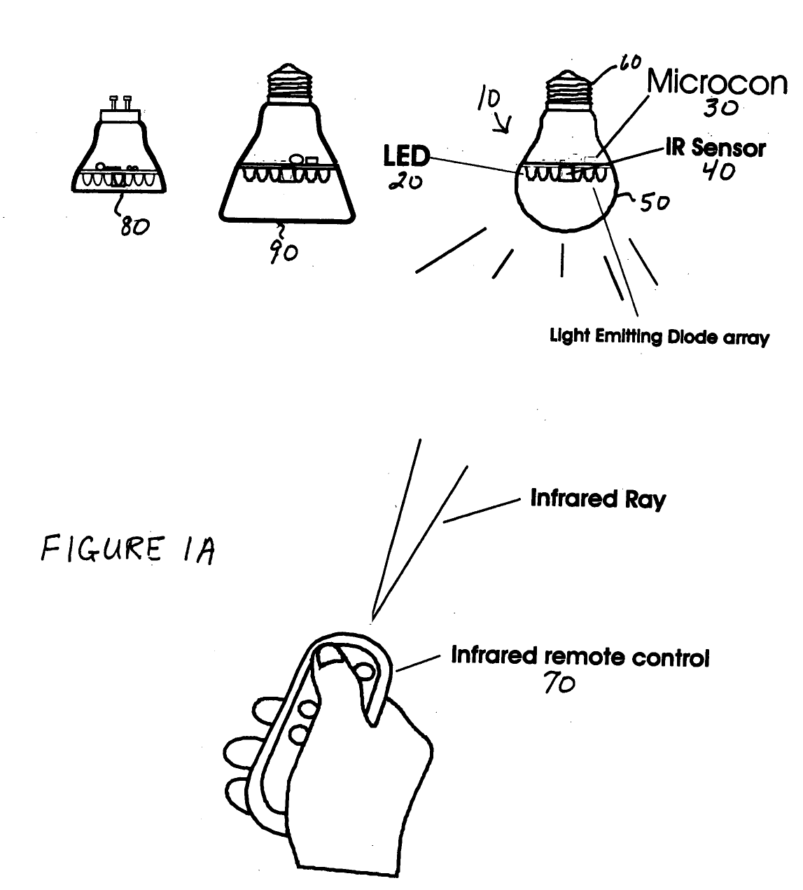

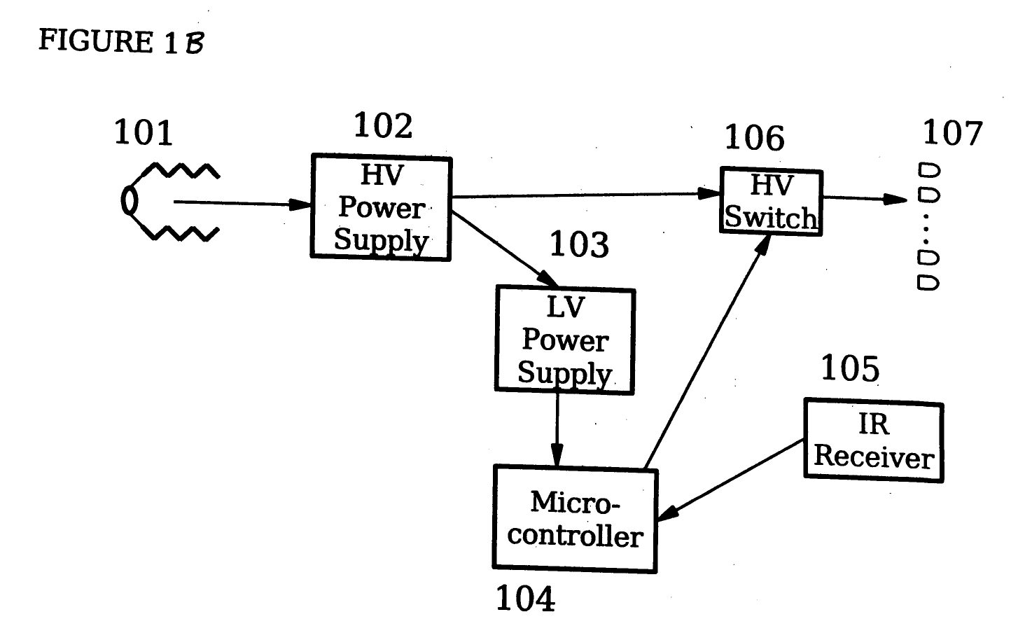

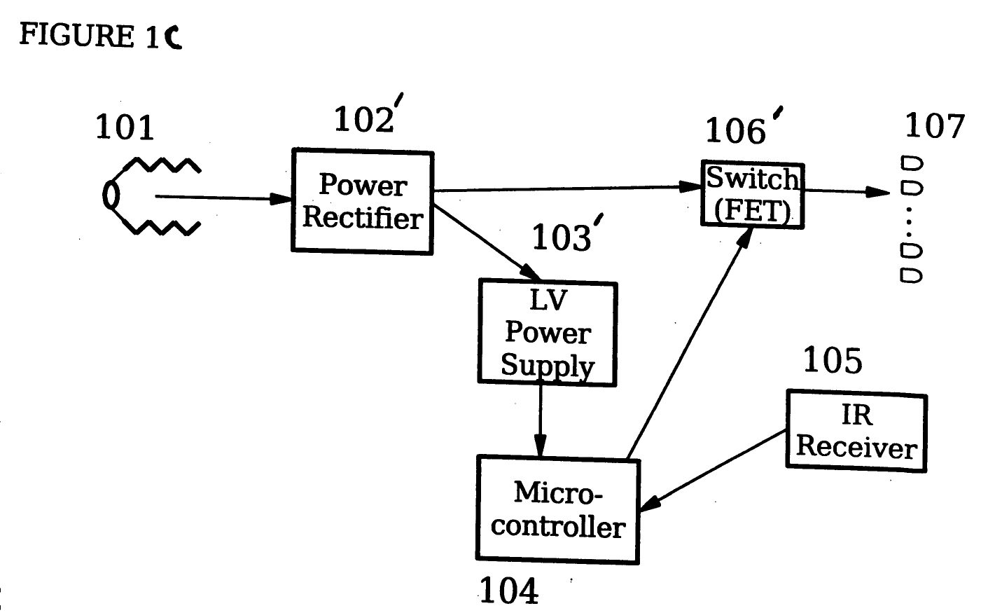

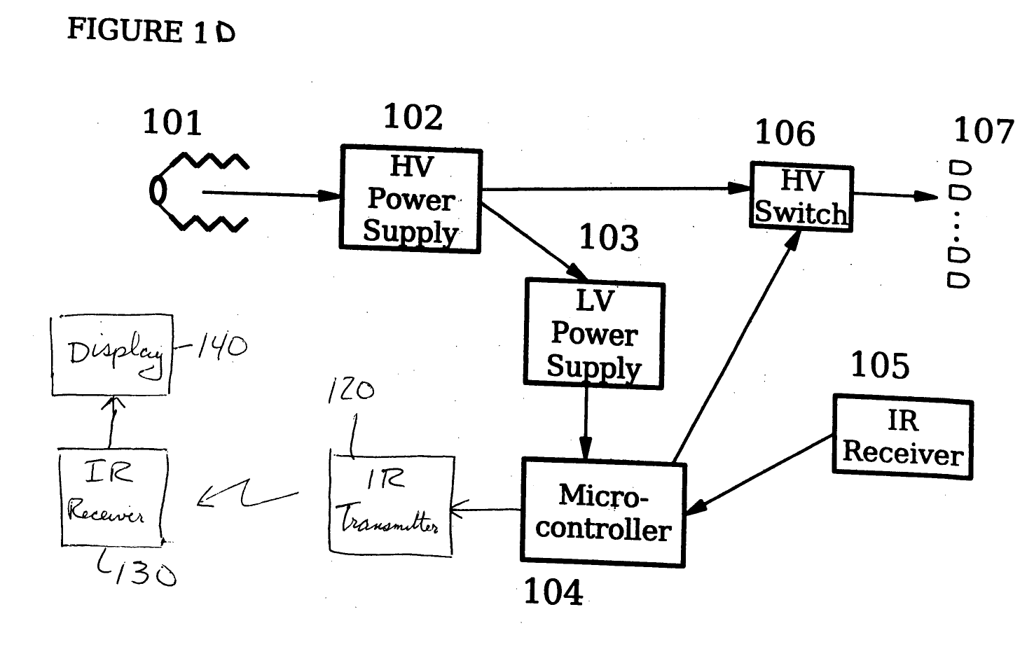

As shown in FIG. 1A, the present invention comprises a light bulb 10 that includes a light emitting diode array 20, a microcontroller 30, and an infrared sensor 40 mounted in an enclosure 50 on a conventional screw thread 60. Preferably, the light emitting diode array emits light at a first visible wavelength and advantageously includes known technology such as a phosphor for converting some of the radiation to at least one other visible wavelength so as to provide an approximation to white light. Also shown in FIG. 1A is a conventional infrared remote control 70 that is used to turn light bulb 10 on and off by interaction with infrared sensor 40.

Light bulb 10 is intended for use in conventional high voltage alternating current (AC) systems such as those in most parts of the world that operate on 110 to 240 volts AC. Also shown in FIG. 1A are a light bulb 80 that is intended for use in a low voltage direct current (DC) environment and a light bulb 90 intended for use in a low voltage AC environment. Any of these light bulbs and others as well may be used in the practice of the invention.

FIG. 1B is a block diagram illustrating the circuitry of light bulb 10 in a first embodiment of the invention. The circuitry comprises a screw plug 101, a high voltage AC to DC power converter 102, a high voltage DC to DC power converter 103, a microcontroller 104, an infrared receiver 105, a high voltage switch 106 and an LED array 107. Power converter 102 converts the AC voltage from screw plug 101 to DC voltage which is supplied to switch 106 and to DC to DC converter 103. DC to DC converter 103 provides power to microcontroller 104. Signals received by infrared receiver 105 from a conventional infrared remote controller such as control 70 of FIG. 1A are provided to microcontroller 104 which interprets the signals to control the operation of switch 106. Switch 106 controls the application of power to LED array 107 in response to signals from the microcontroller, thereby turning the array on or off in response to signals received at receiver 105 from the remote controller.

FIG. 1C is a block diagram illustrating the circuitry of light bulb 10 in a second embodiment of the invention. Several of the elements of FIG. 1C are the same as those of FIG. 1B and bear the same number. The circuitry comprises a screw plug 101, a high voltage AC to DC power converter 102′, a low voltage DC to DC power converter 103′, a microcontroller 104, an infrared receiver 105, a switch 106′ and an LED array 107. Power supply 102′ converts the AC voltage from screw plug 101 to low voltage DC which is supplied to switch 106 and to DC to DC converter 103′. DC to DC converter 103′ provides power to microcontroller 104. Signals received by infrared receiver 105 from a conventional infrared remote controller such as control 70 of FIG. 1A are provided to microcontroller 104 which interprets the signals to control the operation of switch 106′. Switch 106′ controls the application of power to LED array 107 in response to signals from the microcontroller, thereby turning the array on or off in response to signals received at receiver 105 from the remote controller.

FIG. 1D is a block diagram illustrating the circuitry of light bulb 10 in a third embodiment of the invention. The circuitry comprises a screw plug 101, a high voltage AC to DC power converter 102, a high voltage DC to DC power converter 103, a microcontroller 104, an infrared receiver 105, a high voltage switch 106 and an LED array 107 which are the same as the corresponding elements of FIG. 1B and bear the same number. The circuitry further comprises an infrared transmitter 120 powered by power converter 103 and controlled by microcontroller 104. Power converter 102 converts the AC voltage from screw plug 101 to DC voltage which is supplied to switch 106 and to DC to DC converter 103. DC to DC converter 103 provides power to microcontroller 104. Signals received by infrared receiver 105 from a conventional infrared remote controller such as control 70 of FIG. 1A are provided to microcontroller 104 which interprets the signals to control the operation of switch 106. Switch 106 controls the application of power to LED array 107 in response to signals from the microcontroller, thereby turning the array on or off in response to signals received at receiver 105 from the remote controller.

Under control of microcontroller 104, signals are transmitted from infrared transmitter 120 to an infrared receiver 130. The signals received by receiver 130 are processed and used to control a display 140 or other indicator. Illustratively, the signals from transmitter 120 are used to indicate the operational status of the light bulb. For example, the absence of a signal might indicate that the light bulb is off and the presence of a signal might indicate that it is on. Alternatively, a first level of signal from the light bulb might indicate that it is off but has power while a second level of signal might indicate that it is on.

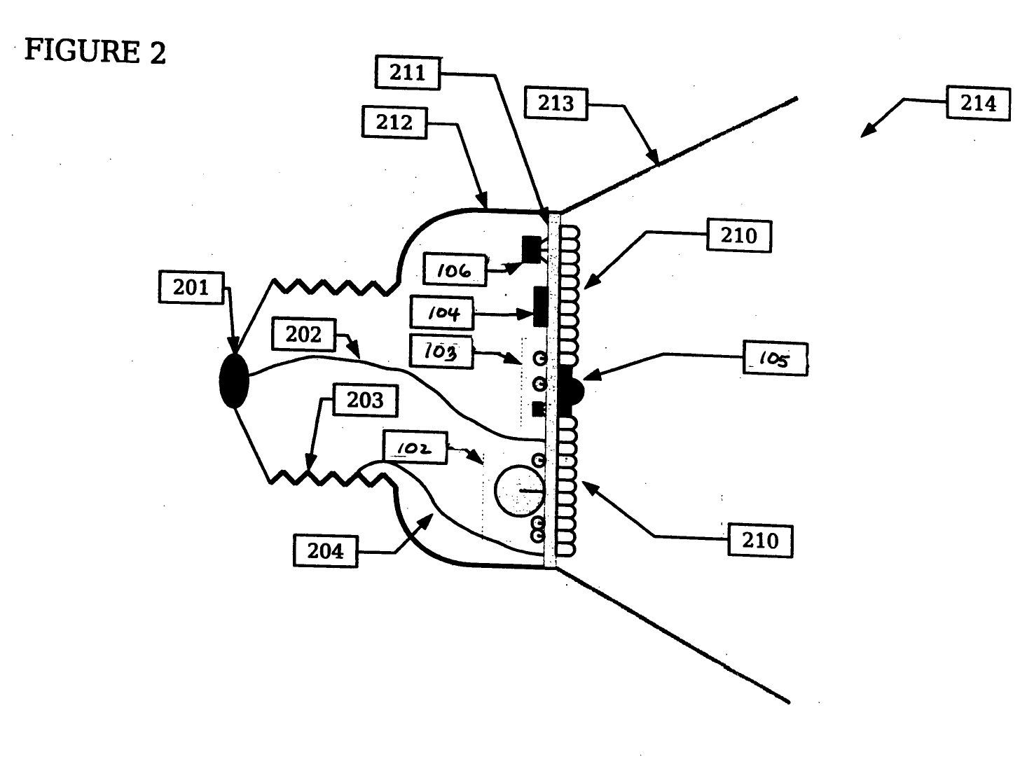

FIG. 2 is a detailed view of one embodiment of a light bulb of the present invention that incorporates the circuitry of FIG. 1B. The bulb comprises high voltage AC to DC power converter 102, high voltage DC to DC power converter 103, microcontroller 104, infrared receiver 105, high voltage switch 106 and LED array 107 mounted on a printed circuit board 211 and connected together as shown in FIG. 1B. The bulb further comprises a hot AC connector tip contact 201, a hot AC wire conductor 202, a neutral AC connector screw contact 203, a neutral AC wire conductor 204, a lamp base 212, a lamp reflector 213 and a lamp lens 214.

High voltage AC to DC power converter 102 converts the AC voltage from the screw plug to DC voltage which is supplied to switch 106 and to high voltage DC to DC power converter 103. Power converter 103 provides power to microcontroller 104. Signals received by infrared receiver 105 from a conventional infrared remote controller such as control 70 of FIG. 1A are provided to microcontroller 104 which interprets the signals to control the operation of switch 106. Switch 106 controls the application of power to LED array 107 in response to signals from the microcontroller, thereby turning the array on or off in response to signals received at receiver 105 from the remote controller.

In similar fashion, the circuitry of FIG. 1C and FIG. 1D can likewise be mounted on a printed circuit board incorporated within a light bulb.

As will be apparent to those skilled in the art, numerous other embodiments may be practiced within the spirit and scope of the invention. For example, while infrared transmitters and receivers are described above for transmitting control signals to the light bulb and status signals from the light bulb, other types of transmitters and receivers may also be used. Likewise the invention may be practical so as to control remotely the operation of any type of LED array.

What is claimed is:

1. A light source comprising:
a light emitting diode emitting radiation at a first wavelength,
first and second contacts for connecting to an alternating current source,
an alternating current to direct current converter for receiving an alternating current from the first and second contacts and converting it to direct current,
a switch for selectivity connecting said direct current from the converter to the light emitting diode, and
a radiation detector operable in response to detected radiation to control said switch to selectivity connect said direct current to the light emitting diode.

2. The light source of claim 1 further comprising a microcontroller for controlling said switch in response to signals from the radiation detector.

3. The light source of claim 1 wherein the radiation detector is an infra-red radiation detector.

4. The light source of claim 1 wherein the first contact is a metal screw thread and the second contact is located at the center of the thread and insulated therefrom.

5. The light source of claim 1 further comprising a wavelength converter for converting some of the radiation to a second wavelength such that the radiation at the first and second wavelengths approximates that from a source of white light.

6. The light source of claim 1 further comprising a radiation transmitter for transmitting a signal indicating operational status of the light source.

7. A system for controlling a light source comprising:
a light bulb comprising
a light emitting diode for emitting radiation at a first wavelength,
first and second contacts for connecting to an alternating current source,
an alternating current to direct current converter for receiving an alternating current from the first and second contacts and converting it to direct current,
a switch for selectivity connecting said direct current from the converter to the light emitting diode, and
a radiation detector operable in response to detected radiation to control said switch to selectivity connect said direct current to the light emitting diode; and
a controller for transmitting control signals to the radiation detector.

8. The system of claim 7 further comprising a microcontroller for controlling said switch in response to signals from the radiation detector.

9. The system of claim 7 wherein the radiation detector is an infra-red radiation detector.

10. The system of claim 7 wherein the first contact is a metal screw thread and the second contact is located at the center of the thread and insulated therefrom.

11. The system of claim 7 further comprising a wavelength converter for converting some of the radiation to a second wavelength such that the radiation at the first and second wavelengths approximates that from a source of white light.

12. The system of claim 7 wherein the controller comprises an infrared transmitter.

13. The system of claim 7 wherein the light bulb further comprises a radiation transmitter for transmitting a signal indicating operational status of the light source.

14. The system of claim 13 wherein the radiation transmitter is an infrared transmitter.

15. The system of claim 13 further comprising a detector for detecting signals transmitted from the transmitter.
